(19) United States
(12) Patent Application Publication
(10) Pub. No.: US 2025/0068688 A1
(43) Pub. Date: Feb. 27, 2025

(54) ACCESSIBILITY ELEMENT IN SOURCE CODE FOR INVOKING VIRTUAL ASSISTANT

(71) Applicant: T-Mobile USA, Inc., Bellevue, WA (US)

(72) Inventors: Qianwen Wen, Herndon, VA (US); Susan Dawn Andreson, Seattle, WA (US); Stephen Dekat, Olathe, KS (US); Jatin Gupta, Herndon, VA (US); Takeshi Hui, Los Angeles, CA (US); Anne Kristiina Joutsenvirta, Seattle, WA (US); Randy Nguyen, Seattle, WA (US); Anisa Proda, Seattle, WA (US); Thomas Vincent Rizzolo, Dallas, TX (US); Sean Harrison Roach, Kenmore, WA (US)

(21) Appl. No.: 18/456,386

(22) Filed: Aug. 25, 2023

(51) Int. Cl. G06F 16/957; G06F 9/451

(52) U.S. Cl. CPC G06F 16/9577; G06F 9/453

(57) ABSTRACT

Described herein is a system for providing access to a virtual assistant using a hidden element in source code of a document. The system can receive a request from a computing device to access a document, which has source code that includes a first set of characters embedded at its beginning. The first set of characters may only be accessible by an accessibility engine design to render data describing a document for individuals with visual impairments. When the accessibility engine parses the first set of characters, the computing device outputs content indicating that the individual can access the virtual assistant by performing an interaction. When the computing device detects the interaction, the computing device invokes the virtual assistant to guide the individual through the document.

### BACKGROUND

A screen reader is a form of assistive technology that renders text and image content as speech or braille output. Screen readers are essential to people who are blind and are useful to people who are visually impaired, illiterate, or have a learning disability. Some screen readers may be implemented on computing devices as software applications that attempt to convey what people with normal eyesight see on a display to their users via non-visual means, like text-to-speech, sound icons, or a braille device. They do this by applying a wide variety of techniques that include, for example, interacting with dedicated accessibility APIs, using various operating system features (like inter-process communication and querying user interface properties), and employing hooking techniques.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a network environment of a virtual assistant.

FIG. 3 is a block diagram that illustrates a process flow representing an expedited browsing experience.

FIG. 4A depicts a first webpage shown on an electronic device and corresponding source code.

FIG. 4B depicts a first set of content output by an electronic device when an accessibility engine parses a first set of characters.

FIG. 4C depicts output at an electronic device by a virtual assistant.

FIG. 4D depicts a virtual assistant guiding a user to a second webpage based on an audio input from the user.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

An individual with a visual impairment may require a form of assistive technology to receive information about the content of a document. For example, an individual with a visual impairment may use a screen reader plug-in on a user device to obtain information about text and image content of a document. The screen reader may convert text on the document into audio and translate what the image content depicts into an audio description, both of which the user device outputs. The individual can interact with the user device to navigate from the document when looking for particular information or a link to another document.

However, despite conventional screen readers' (and other assistive technologies') ability to convert content to audio/braille, individuals may still have difficulty navigating between documents on their computing device. For example, if an individual wants to access a link located at the end of a document, the individual may have to wait until the screen reader converts all of the content above the link to receive information about the link. This is a time-consuming and cumbersome aspect of using screen readers to navigate documents. Thus, a method for streamlining document-navigation using screen readers (or other assistive technology) is necessary.

Described herein are systems and methods for providing access to a virtual assistant configured to help individuals with visual impairments to navigate an artifact, such as a webpage, a document, and so on. For simplicity, the description focuses on the use of a screen reader that outputs audio describing content of webpages. However, in some instances, other assistive technologies that output information (e.g., audio, braille characters, etc.) describing the content of webpages may be used. Examples of other assistive technologies include screen magnifiers, braille embossers, desktop magnifiers, voice recorders, or any other accessibility engine. Further, in some instances, the virtual assistant may be used to help a user navigate within and/or between other documents, applications, and interfaces.

The system receives requests from a user device to access a webpage. The source code of the webpage can include a first set of characters. The first set of characters can be embedded at the beginning of the source code such that the screen reader would parse the first set of characters before the bulk of other content in the source code. The first set of characters may only be accessible by a screen reader (or other accessibility technology) in that the first set of characters are in the source code but not on the visual rendering of the webpage. The first set of characters can indicate accessibility requirements for the webpage. The accessibility requirements indicate that the individual using the user device has a visual impairment and may need assistance to access the full set of content of the webpage. The first set of characters can include a predetermined set of accessibility characters that indicate to the screen reader to offer use of a virtual assistant to the individual. When the screen reader parses those predetermined accessibility characters, the screen reader causes/enables the user device to output signals (e.g., audio, haptic signals, etc.) prompting the individual to invoke the virtual assistant via a particular interaction. The first set of characters (and/or a variation thereof) may also be located at other portions of the source code such that the screen reader can reoffer access to the virtual assistant and respecify the particular interaction upon parsing the first set of characters again.

The virtual assistant can be configured to guide an individual through and between webpages. The webpages may be connected in the same website or may be connected via hyperlinks located within the webpages. The individual can access the virtual assistant by performing the particular interaction with the user device. The interaction may be an audio input, a haptic input, an interaction with a touchscreen or keyboard, or the like. For example, the user device may determine that the interaction has occurred upon detecting a sequence of keyboard inputs, a touch-based input, audio input, or a haptic input captured at the user device.

Once access to the virtual assistant has been invoked via the particular interaction, the virtual assistant can communicate with the user device to guide the individual through the webpage. For example, the virtual assistant can receive audio input from the user device and relay audio information about the webpage back to the individual based on the audio input. Further, the virtual assistant can cause the user device to render another webpage based on the audio input. For instance, when the audio input indicates that the individual is trying to find a cookie recipe in a cookbook, the virtual assistant navigates from a webpage with content describing the cookbook to a webpage with content describing a chocolate chip cookie recipe in the cookbook. In another example, the virtual assistant navigates to a webpage that presents a mobile device for purchase. Rather than converting all of the content on the webpage to audio, the virtual assistant outputs audio describing characteristics of the mobile device that the individual can select before purchase, such as color of the mobile device and how much memory the mobile device has. The virtual assistant can guide the individual through purchase of the mobile device by selecting the individual's desired characteristics (indicated by audio input from the individual) and answering questions the individual has about the mobile device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

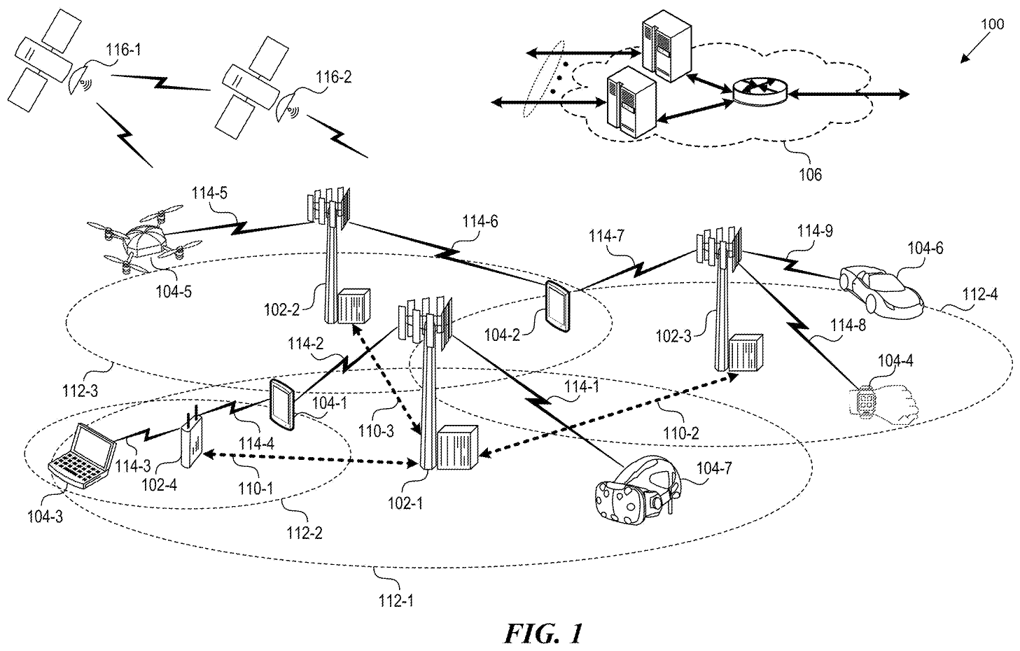

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; loT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### Hidden Characters for Virtual Assistant Access

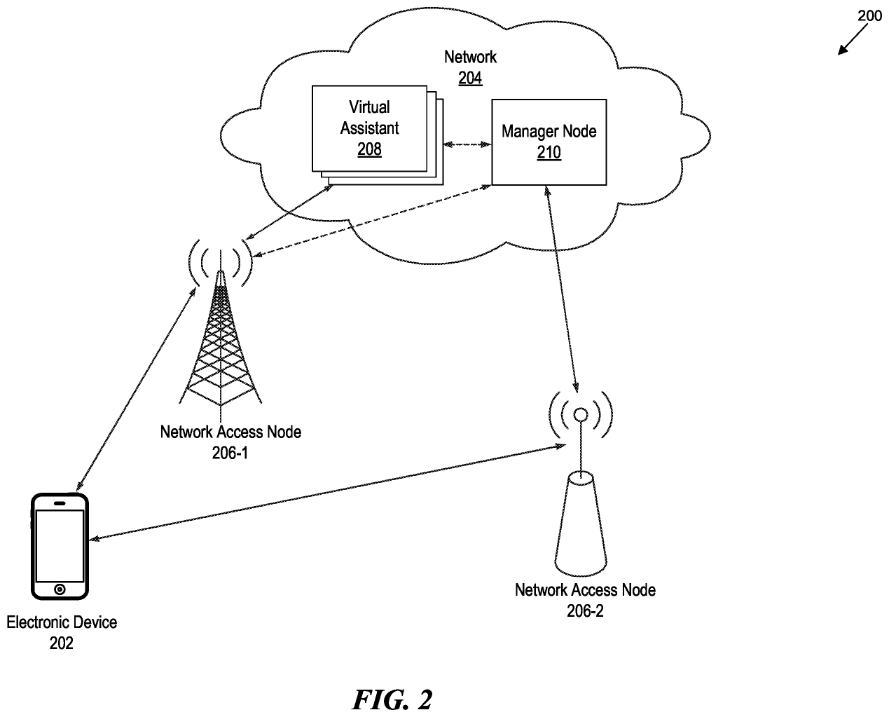

FIG. 2 is a block diagram that illustrates an environment 200 of a virtual assistant. The environment 200 includes an electronic device 202 that is communicatively coupled to one or more networks 204 via network access nodes 206-1 and 206-2 (referred to collectively as network access nodes 206).

The electronic device 202 is any type of electronic device that can communicate wirelessly with a network node and/or with another electronic device in a cellular, computer, and/or mobile communications system. Examples of the electronic device 202 (in some instances, the same as wireless device 104) includes smartphones (e.g., Apple iPhone, Samsung Galaxy), tablet computers (e.g., Apple iPad, Samsung Note, Amazon Fire, Microsoft Surface), wireless devices capable of M2M communication, wearable electronic devices, movable loT devices, and any other handheld device that is capable of accessing the network(s) 204. Although only one electronic device 202 is illustrated in FIG. 2, the disclosed embodiments can include any number of electronic devices.

The electronic device 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 202 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more buses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 206 can be any type of radio network node that can communicate with a wireless device (e.g., electronic device 202) and/or with another network node. The network access nodes 206 can be a network device or apparatus. Examples of network access nodes include a base station (e.g., network access node 206-1), an access point (e.g., network access node 206-2), or any other type of network node such as a network controller, radio network controller (RNC), base station controller (BSC), a relay, transmission points, and the like.

FIG. 2 depicts different types of network access nodes 206 to illustrate that the electronic device 202 can access different types of networks through different types of network access nodes. For example, a base station (e.g., the network access node 206-1) can provide access to a cellular telecommunications system of the network(s) 204. An access point (e.g., the network access node 206-2) is a transceiver that provides access to a computer system of the network(s) 204.

The network(s) 204 can include any combination of private, public, wired, or wireless systems such as a cellular network, a computer network, the Internet, and the like. Any data communicated over the network(s) 204 can be encrypted or unencrypted at various locations or along different portions of the networks. Examples of wireless systems include Wideband Code Division Multiple Access (WCDMA), High Speed Packet Access (HSPA), Wi-Fi, WLAN, Global System for Mobile Communications (GSM), GSM Enhanced Data Rates for Global Evolution (EDGE) Radio Access Network (GERAN), 4G or 5G wireless WWAN, and other systems that can also benefit from exploiting the scope of this disclosure.

The environment 200 includes a manager node 210 that can facilitate interactions between a virtual assistant 208 and the electronic device 202. In some instances, the manager node 210 establishes communication between the virtual assistant and the electronic device 202 such that the virtual assistant 208 and electronic device 202 can directly communicate with one another. In other instances, the manager node 210 transmits communications between the virtual assistant 208 and the electronic device 202. For simplicity, the manager node 210 is described herein as acting as an intermediary for communications between the virtual assistant 208 and electronic device 202.

In some instances, the manager node 210 can include any number of server computers communicatively coupled to the electronic device 202 and virtual assistant 208 via the network access nodes 206. The manager node 210 can include combinations of hardware and/or software to process condition data, perform functions, communicate over the network(s) 204, etc. For example, server computers of the manager node 210 can include a processor, memory or storage, a transceiver, a display, operating system and application software, and the like. Other components, hardware, and/or software included in the environment 200 that are well known to persons skilled in the art are not shown or discussed herein for brevity. Moreover, although shown as being included in the network(s) 204, the manager node 210 can be located anywhere in the environment 200 to implement the disclosed technology.

The electronic device 202 can employ assistive technology, such as a screen reader, to present an individual who is visually impaired with the content of the webpage in an accessible manner (e.g., using cues that involve senses other than eyesight). In some instances, the screen reader may be a plug-in on the electronic device 202 that scans and converts text on a webpage into audio and creates audio describing visual content of the webpage. The screen reader can cause the electronic device 202 to output this audio to the individual. In some instances, the electronic device 202 may output audio describing the organization of the webpage (e.g., table of contents, section headings, etc.), and the individual may interact with the electronic device 202 to select a section of the webpage to hear audio about.

The manager node 210 can receive requests from the electronic device 202 to access a webpage. In some instances, the webpage may be part of a website published by a server of a telecommunications network that employs the manager node 210. The manager node 210 can begin a user session for the electronic device 202, where the user session is indicative of a document browsing experience at the electronic device 202 facilitated by the manager node 210. The manager node 210 can retrieve source code of the requested webpage and transmit the source code to the electronic device for rendering into the webpage as part of the user session. In some instances, the manager node 210 can establish a new user session when the electronic device 202 requests the source code of a new webpage. In other instances, the manager node 210 maintains the same user session for webpages associated with the same website and establishes a new user session when the electronic device 202 requests source code for a webspace not associated with the website.

The source code of a webpage is a collection of data that describes the meaning and structure of content of a webpage (or another document designed to be displayed in a web browser). The source code can be written in HyperText Markup Language (HTML) and can include HTML elements that act as the building blocks of the webpage by embedding constructs, images, and other objects into the webpage once rendered. The HTML elements are delineated by tags that introduce content into the webpage and provide information about content. The source code of the webpage can include hyperlinks to other webpages.

The source code of the webpage can include a first set of characters that indicate accessibility requirements for the webpage. The first set of characters can be in the form of text/alphanumeric elements or may be one or more HTML elements. The accessibility requirements can indicate that the webpage must be accessible to individuals with visual impairments (or other impairments such as hearing loss) such that the individuals can effectively glean the content of the webpage. The first set of characters can be embedded at a beginning of the source code. For example, the first set of characters may be one of the first, if not the first, portion of the source code parsed by the screen reader. In some instances, the first set of characters are the first non-tag element and/or first non-tag metadata in the source code. For example, the source code may include a document type declaration (e.g., “<!DOCTYPE html>”) and tags indicating the structure of the webpage (e.g., “<head>,” “<body>,” etc.), which set up the structure of the source code itself, before the first set of characters. In some instances, the first set of characters are embedded in other locations in the source code, such as at the end of the source code or between HTML elements defining the structure of the webpage (e.g., between chapters, sections, paragraphs, etc.).

The first set of characters can also include a predetermined set of accessibility characters. The predetermined set of accessibility characters may describe a first set of content to be rendered and output upon being parsed by a screen reader. In some instances, the determined set of accessibility characters are a hidden link that enable access by the screen reader to the first set of content. The first set of content can indicate that an individual using the electronic device 202 can access the virtual assistant 208 to navigate the webpage. The first set of content may be expressed as audio, braille, haptic feedback, or any other form of output able to communicate the first set of content to an individual with a visual impairment.

The first set of content can also describe an access interaction the individual can perform via the electronic device 202 to access the virtual assistant 208. Examples of the access interactions include voicing a particular word or phrase, interacting with an interactive element (e.g., a touch screen button, slider, checkbox, etc.) presented at the electronic device 202, a haptic input (e.g., waving or shaking the electronic device 202), and the like. Other examples of interactions include a sequence of keyboard inputs, a touch-based input, audio input, or a haptic input captured at the electronic device 202. In some instances, the predetermined set of accessibility characters can include multiple interactions the individual can perform to access the virtual assistant 208, where each of the multiple interactions may cater to what interactions an individual with a particular visual impairment can perform. For example, an individual who cannot see at all may require using a haptic input for the interaction whereas an individual with farsightedness may be able to interact with an interactive element displayed at the electronic device 202. Further, the first set of content can specify an exit interaction (which may be the same as the access interaction) that the individual can perform to close (e.g., disconnect from communication with) the virtual assistant 208. The individual can perform the access and exit interactions at any time during the user session to invoke/revoke the virtual assistant 208.

The manager node 210 can monitor outputs of the electronic device 202 to determine whether the first set of content has been rendered. In some instances, the manager node 210 may cause the electronic device 202 to send indications of its outputs upon receiving an indication that the screen reader is being applied from the electronic device 202. In other instances, the electronic device 202 may not be able to recognize when the screen reader is operating, so the manager node 210 may instruct the electronic device 202 to send indications of its outputs upon sending the source code of a webpage to the electronic device 202.

When the manager node 210 receives an indication that the electronic device 210 has rendered the first set of content, the manager node 210 instructs the electronic device 202 to send indications describing interactions at the electronic device 202. In some instances, the manager node 210 may instruct the electronic device 202 to send indications about interactions upon transmitting the source code of the webpage to the electronic device 202. The manager node 210 monitors indications from the electronic device 202 for an indication describing the access interaction having been performed at the electronic device 202. Upon receiving an indication that the access interaction was performed, the manager node 210 can establish direct communication between the virtual assistant 208 and the electronic device 202. In some instances, the manager node 210 facilitates communications between the virtual assistant 208 and the electronic device 202. The manager node 210 may establish a new user session upon invoking of the virtual assistant 208 for the electronic device 202, where the new user session includes navigation through the webpage and/or to other webpages in a website that includes the webpage and/or to another webspace not related to the website.

The virtual assistant 208 can be a software application designed to navigate through webpages on a website based on audio and/or textual inputs received from the electronic device 202. The virtual assistant 208 can use natural language processing to assess the audio and/or textual inputs received from the electronic device 202 to determine what the individual is trying to accomplish with the webpage. For example, the virtual assistant 208 may cause the electronic device 202 to output the audio “what are you looking for,” and navigate to a section of the webpage focused on dachshund sleep training techniques upon receiving the audio input “how to train my dachshund to sleep through the night.” In some instances, the virtual assistant 208 may apply a machine learning model or other artificial intelligence (AI) system trained on historic webpage navigation data to determine how to guide the individual. For instance, the virtual assistant 208 can input text received from the electronic device 202 to a machine learning model, which outputs that, based on the text, the individual is looking for a purple dog harness with 90% certainty. The virtual assistant 208 can send outputs of the machine learning model that have over a threshold level of certainty to the electronic device 202 for presentation to the individual. Further, the virtual assistant 208 can save navigation data from each user session to retrain the machine learning model (or other AI system) for future navigation use.

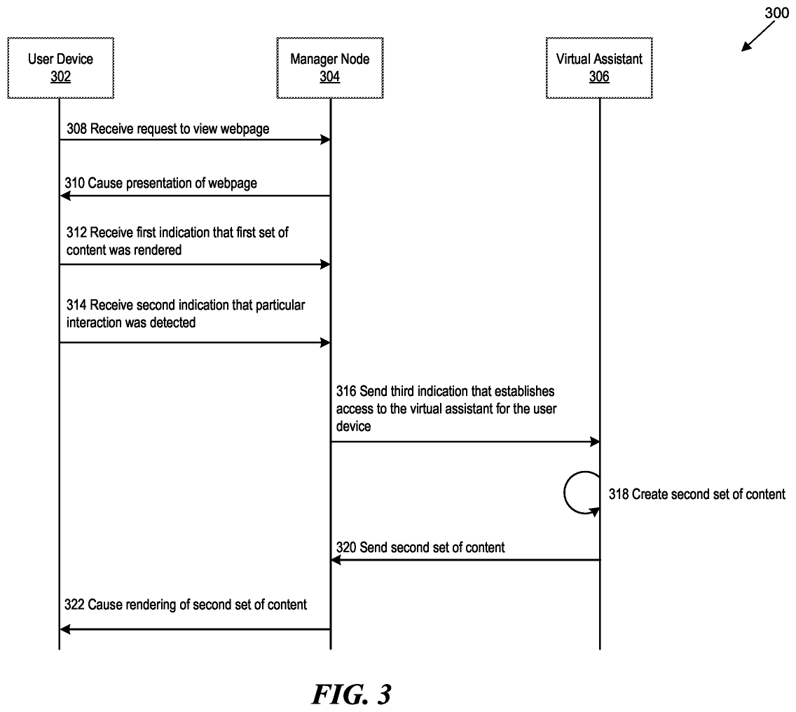

FIG. 3 is a block diagram that illustrates a process flow 300 representing an expedited browsing experience. The process flow 300 includes interactions between a user device 302, manager node 304, and virtual assistant 306. In some instances, the process flow 300 may include additional/alternative components or interactions to those shown in FIG. 3.

At 308, the manager node 304 receives, from the user device 302, a request to view a webpage. In some instances, the webpage may be associated with a website of a telecommunications network and describe a product or service of the telecommunications network. The webpage is associated with source code that describes subject matter of the webpage, and the source code includes a first set of characters embedded at a beginning of the source code but not visible on the webpage when displayed. For example, the first set of characters may be embedded after the tag “<html>,” which denotes the beginning of source code that describes the content of the webpage, but before the tag “<body>,” which denotes the beginning of visible content of the webpage. In some instances, the source code includes multiple copies of the first set of characters embedded in the source code of the webpage. For example, one of the copies of the first set of characters (e.g., a second set of characters) may be embedded after the tag “</body,” which denotes the ending of source code that describes the visible content of the webpage, but before the tag “</html>,” which denotes the ending of the source code of the webpage. The first set of characters indicates accessibility requirements for the webpage, such as being structured to be navigable by individuals with visual impairments or an indication that the individual can invoke the virtual assistant 306 to guide them through the webpage.

The first set of characters matches (or includes) a predetermined set of accessibility characters. The predetermined set of accessibility characters indicate a first set of content for the electronic device 302 to render when parsed by an accessibility engine. The first set of content prompts the user to invoke/request access to the virtual assistant 306 associated with the webpage by inputting a particular interaction to the user device 302. Examples of interactions include performing a haptic input, interacting with an interactive element or physical element of the user device 302, and articulating a particular word, phrase, or sequence of words/phrases. The accessibility engine is a software application, such as a plug-in, on the electronic device 302 that translates the content of the webpage into output(s) for an individual with a visual impairment to understand (e.g., translating visual content into audio or braille content). The accessibility engine may be a screen reader, screen magnifier, braille embosser, desktop video magnifier, or voice recorder. In some embodiments, the accessibility engine may be configured to translate content for individuals with other impairments, such as hearing loss.

At 310, the manager node 304 causes the user device 302 to present the webpage upon transmitting the source code of the webpage to the user device 302. The manager node 304 creates a first user session for the user device 302 and maintains the user session while the webpage is being presented at the user device 302. At 312, the manager node 304 receives, from the user device 302, a first indication that the accessibility engine rendered a first set of content based on the first set of characters. In some instances, the accessibility engine may create and send the indication to the manager node 304. In other instances, the user device 302 monitors its outputs to determine whether the accessibility engine caused the first set of content to be rendered and sends the indication to the manager node 304 upon making the determination.

At 314, the manager node 304 receives a second indication that the user device 302 detected an occurrence of the particular interaction. In response, the manager node 304 enables the user device 302 to access to the virtual assistant 306 in a second user session. For instance, at 316, the manager node 304 sends a third indication to the virtual assistant 306 to enable access by the user device 302. The third indication may specify an identifier of the user device 302, create a communication channel between the user device 302 and virtual assistant 306, and/or create a communication channel between the manager node 304 and virtual assistant 306 for the second user session. In some instances, the second user session is included in the first user session. In other instances, the manager node 304 ends the first user session upon establishing the second user session, which keeps data about the user sessions separate from one another upon storage at the manager node 304.

The virtual assistant 306 is configured to navigate the webpage based on interactions received via the user device 302 (or from the user device 302 via the manager node 304). In some examples, the virtual assistant 306 is configured to navigate a website that includes the webpage and is associated with a telecommunications network. At 318, the virtual assistant 306 creates a second set of content based on the third indication. The second set of content may be a description of how to use the virtual assistant 306 to navigate the webpage, information about the webpage, or a question about what the individual is trying to find on the webpage. At 320, the virtual assistant 306 sends 320 the second set of content to the manager node 304, which causes the user device 302 to render the second set of content (e.g., output audio or braille characters describing the second set of content) at 322. Alternatively, the virtual assistant 306 may directly cause the user device 302 to render the second set of content.

In some instances, the process flow 300 includes additional interactions not shown in FIG. 3. For example, the manager node 304 may receive a fourth indication that the user device 302 detected a second interaction with a hyperlink to a second webpage, indicating that the individual wants to navigate to a second webpage. In this example, the second webpage may include content describing a service or product of a telecommunications network that is references in the source code of the webpage. The manager node 304 may cause the user device to navigate to the second webpage during the second user session. In some instances, the manager node 304 may begin a third user session associated with the second webpage or may include navigation to and interactions with the second webpage as part of the first user session. The manager node 304 may store data escribing this navigation and interactions to train a machine learning model applied by the virtual assistant 306.

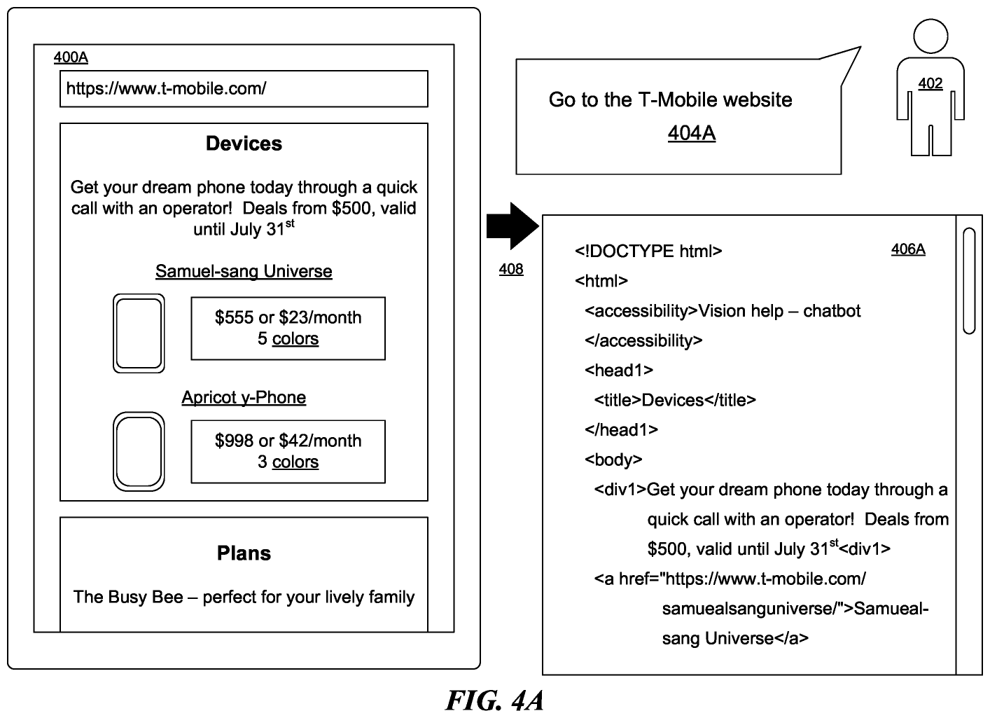

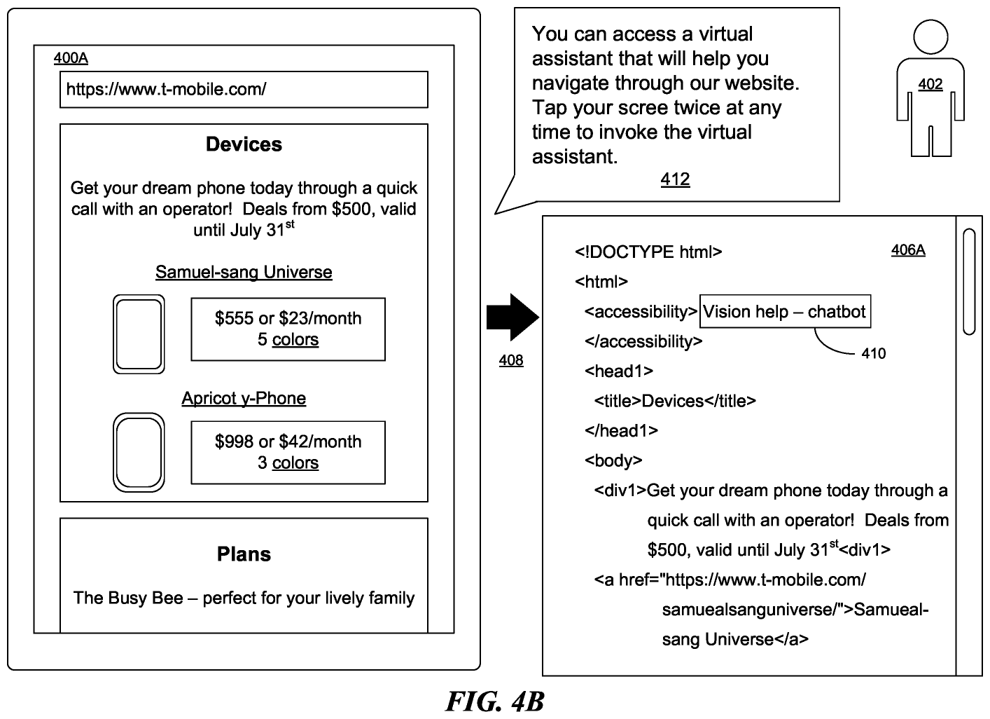

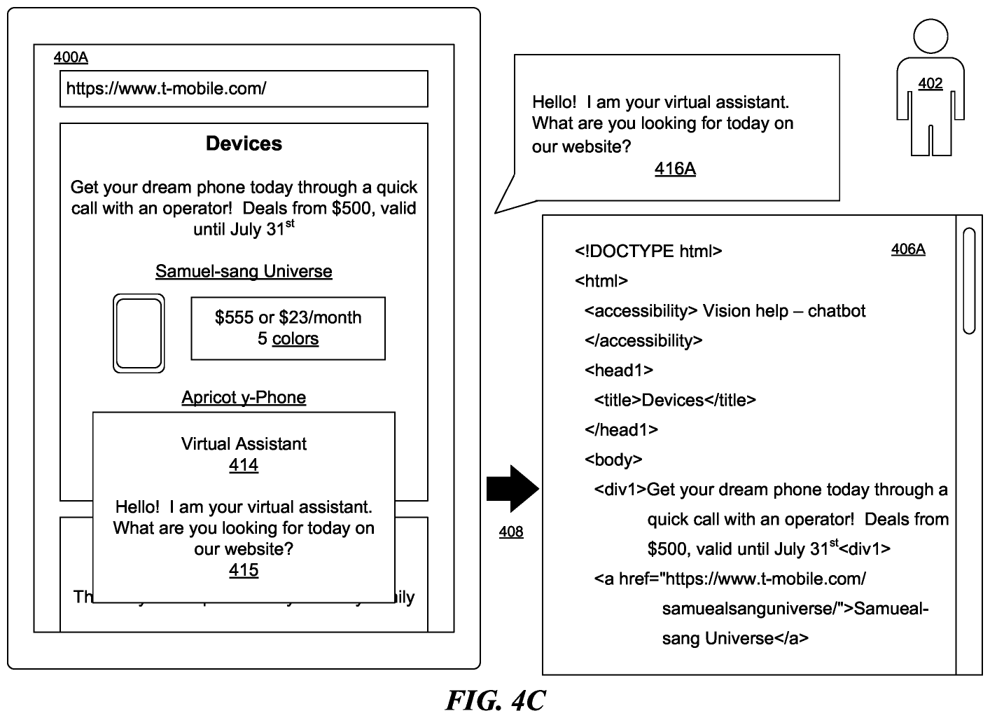

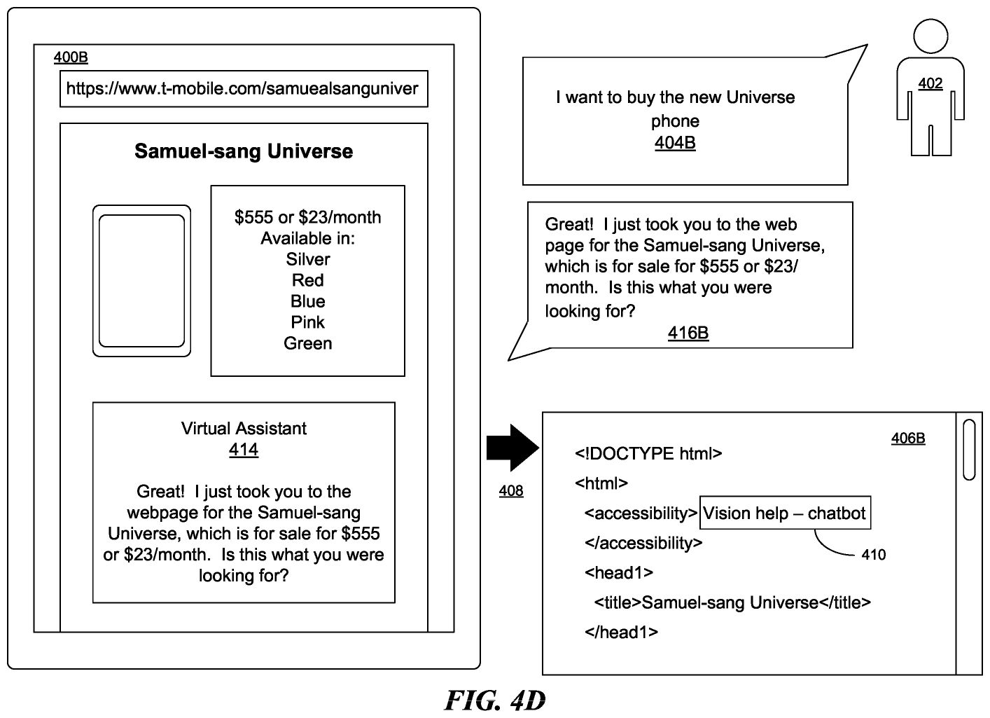

FIG. 4A depicts a first webpage 400A shown on an electronic device. The first webpage can be displayed on the electronic device when a user 402 provides an audio input 404A asking to navigate to a website of the first webpage. The first webpage shows devices that are for sale, which are described by the source code 406A that corresponds to the first webpage. An accessibility engine at the electronic device has not begun parsing the source code 406 in FIG. 4A, as represented by the parser 408 pointing above the first line of the source code 406A.

FIG. 4B depicts a first set of content 412 output by the electronic device when the accessibility engine parses a first set of characters 410. The first set of characters includes accessibility requirements (e.g., abbreviated to “Vision help”) and a predetermined set of accessibility characters (e.g., “chatbot”) that indicates that a virtual assistant is available for access by the user 402. In some instance, the first set of characters is an element or link that connects to the virtual assistant. When the parser 408 reaches the first set of characters, the accessibility engine causes the electronic device to output the first set of content 412 offering access to the virtual assistant for navigating the first webpage 400A and website. As indicated by the first set of content, the user 402 can accept the offer to access the virtual assistant by performing a particular interaction (e.g. tapping the display of the electronic device twice).

FIG. 4C depicts output by the virtual assistant 414. The virtual assistant 414 can cause the electronic device to produce an audio output 416A designed to guide the user through the first webpage 400A and website. The virtual assistant 414 may also be represented by an element 415 on the first webpage.

FIG. 4D depicts the virtual assistant 414 guiding the user 402 to a second webpage based on an audio input 404B from the user 402. Since the user 402 asked about a particular device available on the website (e.g., the Samuel-sang Universe), the virtual assistant 414 caused the electronic device to display a second webpage 400B associated with the particular device. The virtual assistant 414 also caused the electronic device to produce an audio output 416B describing the second webpage 400B as part of navigating the user 402. The source code 406B of the second webpage 400B also includes the first set of characters 410 such that the accessibility engine can offer the user 402 access to the virtual assistant 414 again if the user 402 exits from the virtual assistant 414.

### Computer System

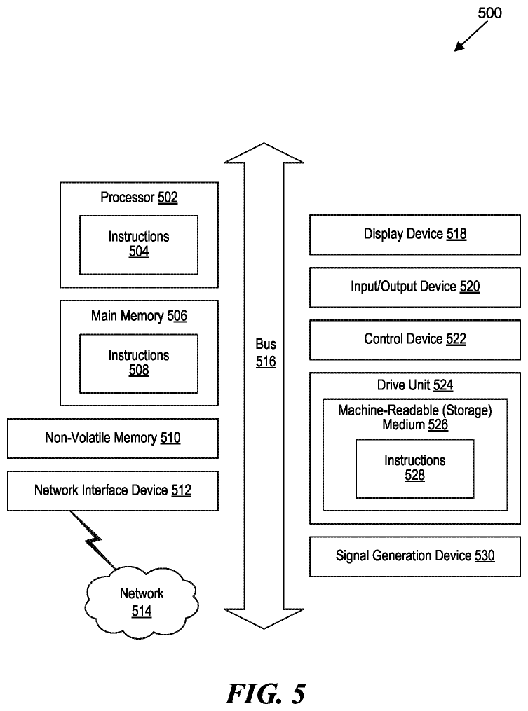

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500 and can be included in the electronic device 202 of FIG. 2. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502 (such as the processor of the electronic device 202), the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A non-transitory, computer-readable storage medium comprising instructions recorded thereon that, when executed by at least one processor of a system of a wireless telecommunications network, cause the system perform actions comprising:
receiving, from a user device, a request to view a webpage associated with a telecommunications network, wherein:
the webpage is associated with source code that describes subject matter of the webpage, the source code including a first set of characters embedded at a beginning of the source code, the first set of characters indicating accessibility requirements and matching a predetermined set of accessibility characters, and
causing the user device to present the webpage;
receiving, from the user device during a first user session, a first indication that an accessibility engine rendered a first set of content based on the first set of characters,
wherein the first set of content enables a user to access to a virtual assistant associated with the telecommunications network by inputting a particular interaction to the user device,
the virtual assistant configured to navigate the webpage based on interactions received via the user device; and
in response to receiving a second indication that the user device detected the particular interaction, enabling the user device to access to the virtual assistant in a second user session.

2. The non-transitory, computer-readable storage medium of claim 1, the actions further comprising:
receiving a third indication that the user device detected a second interaction; and
causing the user device to navigate to a second webpage during the second user session based on the second interaction.

3. The non-transitory, computer-readable storage medium of claim 1, wherein the first user session and the second user session are the same user session.

4. The non-transitory, computer-readable storage medium of claim 1, wherein the accessibility engine is one of a screen reader, screen magnifier, braille embosser, desktop video magnifier, or voice recorder.

5. The non-transitory, computer-readable storage medium of claim 1, wherein the source code further includes a second set of characters embedded at the end of the source code, wherein the second set of characters is associated with the first set of content.

6. The non-transitory, computer-readable storage medium of claim 1, wherein the virtual assistant is configured to navigate a website associated with the telecommunications network and the website includes the webpage.

7. The non-transitory, computer-readable storage medium of claim 1, wherein the particular interaction is associated with a sequence of keyboard inputs, a touch-based input, audio input, or a haptic input captured at the user device.

8. The non-transitory, computer-readable storage medium of claim 1, wherein the source code of the webpage includes a hyperlink to a second webpage.

9. The non-transitory, computer-readable storage medium of claim 8, wherein the second webpage is associated with a product of the telecommunications network referenced in the source code of the webpage.

10. A system comprising:
at least one hardware processor; and
at least one non-transitory memory storing instructions, which, when executed by the at least one hardware processor, cause the system to perform actions comprising:
receiving, from a computing device, a request to view a webpage, wherein:
the webpage is associated with data that describes content of the webpage, the data including a first set of characters embedded at a beginning of the data, the first set of characters indicating accessibility requirements and matching a predetermined set of accessibility characters, and
causing the computing device to present the webpage;
receiving, from the computing device during a first user session, a first indication that an accessibility engine generated a first set of content based on the first set of characters,
wherein the first set of content prompts a user to invoke a virtual assistant associated by inputting a particular interaction to the computing device,
the virtual assistant configured to navigate the webpage based on interactions received via the computing device; and
in response to receiving a second indication that the computing device detected the particular interaction, enabling the computing device to access to the virtual assistant in a second user session.

11. The system of claim 10, the actions further comprising:
receiving a third indication that the computing device detected a second interaction; and
causing the computing device to navigate to a second webpage during the second user session based on the second interaction.

12. The system of claim 10, wherein the first user session and the second user session are the same user session.

13. The system of claim 10, wherein the accessibility engine is one of a screen reader, screen magnifier, braille embosser, desktop video magnifier, or voice recorder.

14. The system of claim 10, wherein the data further includes a second set of characters embedded at the end of the data, wherein the second set of characters is associated with the first set of content.

15. The system of claim 10, wherein the virtual assistant is configured to navigate a website associated with the webpage.

16. The system of claim 10, wherein the particular interaction is associated with a sequence of keyboard inputs, a touch-based input, audio input, or a haptic input captured at the computing device.

17. The system of claim 10, wherein the data of the webpage includes a hyperlink to a second webpage.

18. The system of claim 17, wherein the second webpage is associated with a product referenced in the data of the webpage.

19. A method for providing an expedited browsing experience, the method comprising:
receiving, from a computing device, a request to view a webpage, wherein:
the webpage is associated with data that describes content of the webpage, the data including a first set of characters embedded at a beginning of the data, the first set of characters indicating accessibility requirements and matching a predetermined set of accessibility characters, and
causing the computing device to present the webpage;
receiving, from the computing device during a first user session, a first indication that an accessibility engine rendered a first set of content based on the first set of characters,
wherein the first set of content prompts a user to invoke a virtual assistant associated by inputting a particular interaction to the computing device,
the virtual assistant configured to navigate the webpage based on interactions received via the computing device; and
in response to receiving a second indication that the computing device detected the particular interaction, enabling the computing device to access to the virtual assistant in a second user session.

20. The method of claim 19, further comprising:
receiving a third indication that the computing device detected a second interaction; and
causing the computing device to navigate to a second webpage during the second user session based on the second interaction.
